(19) United States
(12) Patent Application Publication
(10) Pub. No.: US 2014/0062875 A1
(43) Pub. Date: Mar. 6, 2014

(54) MOBILE DEVICE WITH AN INERTIAL MEASUREMENT UNIT TO ADJUST STATE OF GRAPHICAL USER INTERFACE OR A NATURAL LANGUAGE PROCESSING UNIT, AND INCLUDING A HOVER SENSING FUNCTION

(71) Applicants: Richter RAFEY, Santa Clara, CA (US); David Kryze, Campbell, CA (US); Junnosuke Kurihara, Milpitas, CA (US); Andrew Maturi, San Jose, CA (US); Kevin Schwall, Fremont, CA (US)

(72) Inventors: Richter RAFEY, Santa Clara, CA (US); David Kryze, Campbell, CA (US); Junnosuke Kurihara, Milpitas, CA (US); Andrew Maturi, San Jose, CA (US); Kevin Schwall, Fremont, CA (US)

(73) Assignee: PANASONIC CORPORATION, Osaka (JP)

(21) Appl. No.: 13/605,842

(22) Filed: Sep. 6, 2012

(51) Int. Cl. G06F 3/041; G06F 17/27

(52) U.S. Cl. 345/158

(57) ABSTRACT

A mobile device has an inertial measurement unit (IMU) that senses linear and rotational movement, a touch screen including (i) a touch-sensitive surface and (ii) a 3D sensing unit, and a state change determination module that determines state changes from a combination of (i) an output of the IMU and (ii) the 3D sensing unit sensing the hovering object. The mobile device may include a pan/zoom module. A mobile device may include a natural language processing (NLP) module that predicts a next key entry based on xy positions of keys so far touched, xy trajectory of the hovering object and NLP statistical modeling. A graphical user interface (GUI) visually highlights a predicted next key and presents a set of predicted words arranged around the current key above which the object is hovering as selectable buttons to enable entry of a complete word from the set of predicted words.

### BACKGROUND

This application relates to mobile devices with a hover-enabled touch screen system that can perform both touch and hover sensing. The touch screen system includes an array of touch and hover sensors that detect and process touch events (that is, touching of fingers or other objects upon a touch-sensitive surface at particular coordinates within xy dimensions of the screen) and hover events (close proximity hovering of fingers or other objects above the touch-sensitive surface). As used herein, the term mobile device refers to a portable computing and communications device, such as a cell phone. This application relates to state change determination from a combination of an output of an inertial measurement unit (IMU) sensing at least one of a linear movement of the device and a rotational movement of the device and a three-dimensional (3D) sensing unit sensing the object hovering in the z dimension above the touch screen. This application further relates to next word prediction based on natural language processing (NLP) in personal computers and portable devices having a hover-enabled touch screen system that can perform both touch and hover sensing.

Touch screens are becoming increasingly popular in the fields of personal computers and portable devices such as smart phones, cellular phones, portable media players (PMPs), personal digital assistants (PDAs), game consoles, and the like. Presently, there are many types of touch screens: resistive, surface acoustic wave, capacitive, infrared, optical imaging, dispersive signal technology, and acoustic pulse recognition. Among capacitive-based touch screens, there are two basic types: surface capacitance, and projected capacitance which can involve mutual capacitance or self-capacitance. Each type of touch screen technology has its own features, advantages and disadvantages.

A typical touch screen is an electronic visual display that can detect the presence and location of a touch within the display area to provide a user interface component. Touch screens provide a simple smooth surface, and enable direct interaction (without any hardware (keyboard or mouse)) between the user and the displayed content via an array of touchscreen sensors built into the touch screen system. The sensors provide an output to an accompanying controller-based system that uses a combination of hardware, software and firmware to control the various portions of the overall computer or portable device of which the touch screen system forms a part.

The physical structure of a typical touch screen is configured to implement main functions such as recognition of a touch of the display area by an object, interpretation of the command that this touch represents, and communication of the command to the appropriate application. In each case, the system determines the intended command based on the user interface displayed on the screen at the time and the location of the touch. The popular capacitive or resistive approach includes typically four layers. A top layer of polyester coated with a transparent metallic conductive coating on the bottom, an adhesive spacer, a glass layer coated with a transparent metallic conductive coating on the top, and an adhesive layer on the backside of the glass for mounting. When a user touches the surface, the system records the change in the electrical properties of the conductive layers. In infrared-based approaches, an array of sensors detects a finger touching (or almost touching) the display, the finger interrupting light beams projected over the screen, or bottom-mounted infrared cameras may be used to record screen touches.

Current technologies for touch screen systems also provide a tracking function known as “hover” or “proximity” sensing, wherein the touch screen system includes proximity or hover sensors that can detect fingers or other objects hovering above the touch-sensitive surface of the touch screen. Thus, the proximity or hover sensors are able to detect a finger or object that is outside the detection capabilities of the touch sensors.

Presently, many mobile devices include an inertial measurement unit (IMU) to sense linear (accelerometer) and rotational (gyroscope) gestures. However, in current IMU-enabled mobile phones, certain actions are quite challenging for one-handed interaction. For example, zooming is typically a two-finger operation based on multitouch. Also, panning and zooming simultaneously using standard interaction is difficult, even though this is a fundamental operation (e.g., with cameras), Accelerometers that are built into smartphones provide a very tangible mechanism for user control, but due to difficult one-handed operations, they are seldom used for fundamental operations like panning within a user interface (except for augmented reality applications). While IMU-based gestures have great potential based on gyroscopes built into devices, they are seldom used in real applications because it is not clear whether abrupt gestures (subtler than “shaking”) are intentional.

Moreover, current touchscreens on portable devices such as smartphones have small keyboards that make text entry challenging. Users often miss the key they want to press and have to interrupt their flow to make corrections. Even though there is very rich technology for next word prediction based on natural language processing (NLP), the act of text entry mostly involves entering individual keystrokes. Current prediction technology fails to optimize the keystroke process. Also, in the case of continuous touch interfaces (e.g., Swype™), lifting the finger off the keyboard is the only way to end a trajectory and signal a word break, while the user must change the prediction if it is wrong, leading to frequent corrections.

The statements above are intended merely to provide background information related to the subject matter of the present application and may not constitute prior art.

### SUMMARY

In embodiments herein, a hover-enabled touch screen based on self-capacitance combines hover tracking with IMU to support single-finger GUI state changes and pan/zoom operations via simple multi-modal gestures.

In embodiments, a mobile device comprises an inertial measurement unit (IMU) that senses linear and rotational movement of the device in response to gestures of a user's hand while holding the device; a touch screen system comprising (i) a touch-sensitive surface including xy dimensions, and (ii) a 3D sensing unit configured to sense an object hovering in a z dimension above the touch screen and to detect a location in the xyz dimensions of the object hovering above the touch screen; and a state change determination module that determines state changes from a combination of (i) an output of the IMU sensing at least one of a linear movement of the device and a rotational movement of the device and (ii) the 3D sensing unit sensing the object hovering in the z dimension above the touch screen.

In further embodiments, a mobile device comprises an inertial measurement unit (IMU) that senses linear and rotational movement of the device in response to gestures of a user's hand while holding the device; a touch screen system comprising (i) a touch-sensitive surface including xy dimensions and (ii) a 3D sensing unit configured to sense an object hovering in a z dimension above the touch screen and to detect a location in the xyz dimensions of the object hovering above the touch screen and sense movement of the object in the xy dimensions; and a pan/zoom module that, in response to detection of the object hovering above the touch screen in a steady position in the xy dimensions of the touch-sensitive surface for a predetermined period of time or a detection of another activation event, enables a pan/zoom mode that includes (i) panning of the image on the touch screen based on the 3D sensing unit sensing movement of the object in the xy dimensions and (ii) zooming of the image on the touch screen based on detection by the 3D sensing unit of a hover position of the object in the z dimension above the touch screen.

In embodiments, the state changes may include changes of keyboard character sets. The state changes may be made based on tilt and hover or flick and hover or tilt or flick with a sustained touch of the screen. Flick is defined herein as an abrupt, short in length, linear movement of the device detected via the accelerometer function of the device. Tilt is defined herein as an abrupt tilt of the device detected via the gyroscope function or accelerometer function of the device. Repeating a tilt and hover operation may cause the device to move to a next mode. Performing a tilt in the opposite direction of the previous tilt and hover operation may cause the device to move to a previous mode; it should be noted that the same gesture (tilt versus flick) need not be performed in both directions, rather there is a choice of gestures and they are directional. The mobile device may include a graphical user interface (GUI) that provides animation that provides visual feedback to the user that is physically consistent with the direction of the tilt or flick.

In embodiments, the pan/zoom module may enable panning and zooming of the image in response to outputs of one or more of the hover sensor, the xy sensor and the IMU. The 3D sensing unit may sense both hovering in the z dimension and touching of the screen by the object in the xy dimensions. The pan mode may be based on detection of a hover event simultaneous with movement of the device in the xy dimensions. The zoom mode may be based on detection of a hover event simultaneous with movement of the device in the z direction.

In embodiments, methods of operating a mobile device and computer-readable storage media containing program code enabling operation of a mobile device, according to the above principles are also provided.

In embodiments relating to NLP, this application combines hover-based data regarding finger trajectory with keyboard geometry and NLP statistical modeling to predict a next word or character.

In embodiments herein, a mobile device comprises a touch screen system comprising (i) a touch-sensitive surface including xy dimensions, and (ii) a 3D sensing unit configured to sense an object hovering in a z dimension above the touch screen and to detect a location in the xy dimensions of the object hovering above the touch screen and sense movement of the object in the xy dimensions; a natural language processing (NLP) module that predicts a keyboard entry based on information comprising (i) xy positions relating to keys so far touched on the touch screen, (ii) an output from the 3D sensing unit indicating xy position of the object hovering above the touch screen, (iii) an output from the 3D sensing unit indicating xy trajectory of movement of the object in the xy dimensions of the touch screen, and (iv) NLP statistical modeling based on natural language patterns, the keyboard entry predicted by the NLP module comprising at least one of a set of predicted words and a predicted next keyboard entry; and a graphical user interface (GUI) module that highlights the predicted next keyboard entry with a visual highlight in accordance with xy distance of the object hovering above the touch screen to the predicted next keyboard entry. The GUI may, in response to the object not touching the predicted next keyboard entry, continue the visual highlight until the NLP module changes the predicted next keyboard entry, and, in response to the object touching the predicted next keyboard entry, remove the visual highlight, and in response to the GUI module removing the visual highlight, the information provided to the NLP module may be updated with the touching of the previously highlighted keyboard entry and current hover and trajectory of the object and the NLP module may generate another predicted next keyboard entry based on the updated entry.

In further embodiments herein, a mobile device comprises a touch screen system comprising (i) a touch-sensitive surface including xy dimensions, and (ii) a 3D sensing unit configured to sense an object hovering in a z dimension above the touch screen and to detect a location in the xy dimensions of the object hovering above the touch screen and sense movement of the object in the xy dimensions; a natural language processing (NLP) module that predicts a keyboard entry based on information comprising (i) xy positions relating to keys so far touched on the touch screen, (ii) an output from the 3D sensing unit indicating xy position of the object hovering above the touch screen, (iii) an output from the 3D sensing unit indicating the current key above which the object is hovering, and (iv) NLP statistical modeling based on natural language patterns, the keyboard entry predicted by the NLP module comprising a set of predicted words should the user decide to press the current key above which the object is hovering; and a graphical user interface (GUI) module that presents the set of predicted words arranged around the current key above which the object is hovering as selectable buttons to enter a complete word from the set of predicted words. The GUI, in accordance with the dimensions of the hover-sensed object, may control arrangement of the set of selectable buttons representing the predicted words to be positioned beyond the dimensions of the hover-sensed object to avoid visual occlusion of the user. The 3D sensing unit may be configured to detect a case of hovering over a backspace key to enable presenting word replacements for the last word entered. The GUI may independently treat the visual indicator of the predicted next keyboard entry versus the physical target that would constitute a touch of that key. In particular, the visual indicator may be larger than the physical target area to attract more attention to the key while requiring the normal keypress or the physical target area may be larger to facilitate pressing the target key without distorting the visible keyboard.

In embodiments, methods of operating a mobile device and computer-readable storage media containing program code enabling operation of a mobile device, according to the above principles are also provided.

### BRIEF DESCRIPTION OF THE SEVERAL VIEWS OF THE DRAWINGS

Embodiments of this application will be explained in more detail in conjunction with the appended drawings, in which:

FIGS. 1A and 1B disclose a mobile device according to embodiments of this application employing an IMU;

FIG. 2 illustrates an aspect of this application relating to the mobile devices according to FIGS. 1A and 1B and 9A and 9B;

FIG. 3 shows xyz dimensions relative to the mobile devices of FIGS. 1A and 1B and 9A and 9B;

FIG. 4 is a flow chart that illustrates features of embodiments of this application employing an IMU;

FIG. 5 is a flow chart that illustrates further features of embodiments of this application employing an IMU;

FIG. 6 illustrates an aspect of embodiments of this application by showing a finger hovering above the touch sensitive screen while moving the phone in the z direction to facilitate a one-handed zoom;

FIG. 7 illustrates an aspect of embodiments of this application by showing a finger hovering above the touch sensitive screen while moving the phone in the xy dimensions to facilitate one-handed panning;

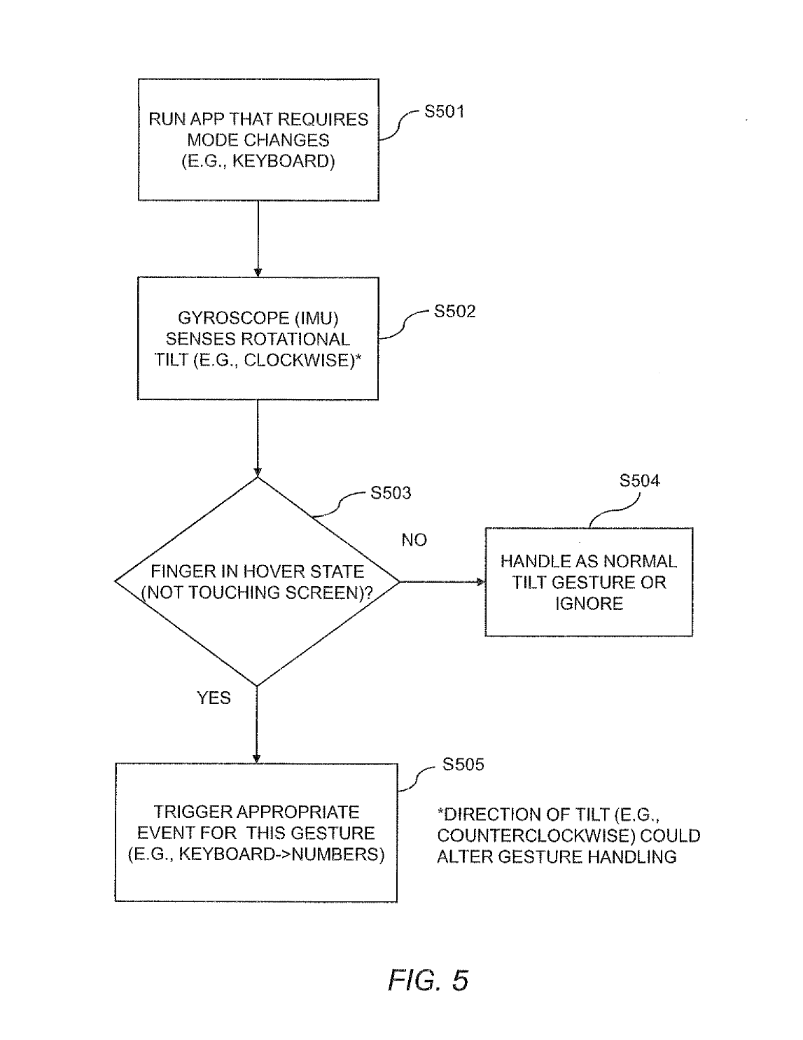

FIGS. 5A, 8B and 8C illustrate aspects of this application wherein a finger hovering above the touch sensitive screen while tilting triggers a state change with a simple one-handed action;

FIGS. 9A and 9B disclose a mobile device according to embodiments of this application relating to NLP;

FIG. 10 is a flow chart that illustrates features of embodiments of this application relating to NLP; and

FIGS. 11A, 11B, 11C, 11D, 11E, and 11F illustrate how predicted words change after a keypress based on characters entered so far and the attractor character is based on a combination of initial hover trajectory and word probabilities.

### DETAILED DESCRIPTION

Exemplary embodiments will now be described. It is understood by those skilled in the art, however, that the following embodiments are exemplary only, and that the present invention is not limited to these embodiments.

As used herein, a touch sensitive device can include a touch sensor panel, which can be a clear panel with a touch sensitive surface, and a display device such as a liquid crystal display (LCD) positioned partially or fully behind the panel or integrated with the panel so that the touch sensitive surface can cover at least a portion of the viewable area of the display device. The touch sensitive device allows a user to perform various functions by touching the touch sensor panel using a finger, stylus or other object at a location often dictated by a user interface (UI) being displayed by the display device. In general, the touch sensitive device can recognize a touch event and the position of the touch event on the touch sensor panel, and the computing system can then interpret the touch event in accordance with the display appearing at the time of the touch event, and thereafter can perform one or more actions based on the touch event. The touch sensitive device of this application can also recognize a hover event, i.e., an object near but not touching the touch sensor panel, and the position, within xy dimensions of the screen, of the hover event at the panel. The touch sensitive device can interpret the hover event in accordance with the user interface appearing at the time of the hover event, and thereafter can perform one or more actions based on the hover event. As used herein, the term “touch screen” refers to a device that is able to detect both touch and hover events. An example of a touch screen system including a hover or proximity tracking function is provided by U.S. application number 2006/0161870.

### Employing IMU for Determining State Changes and for Pan/Zooming Functions

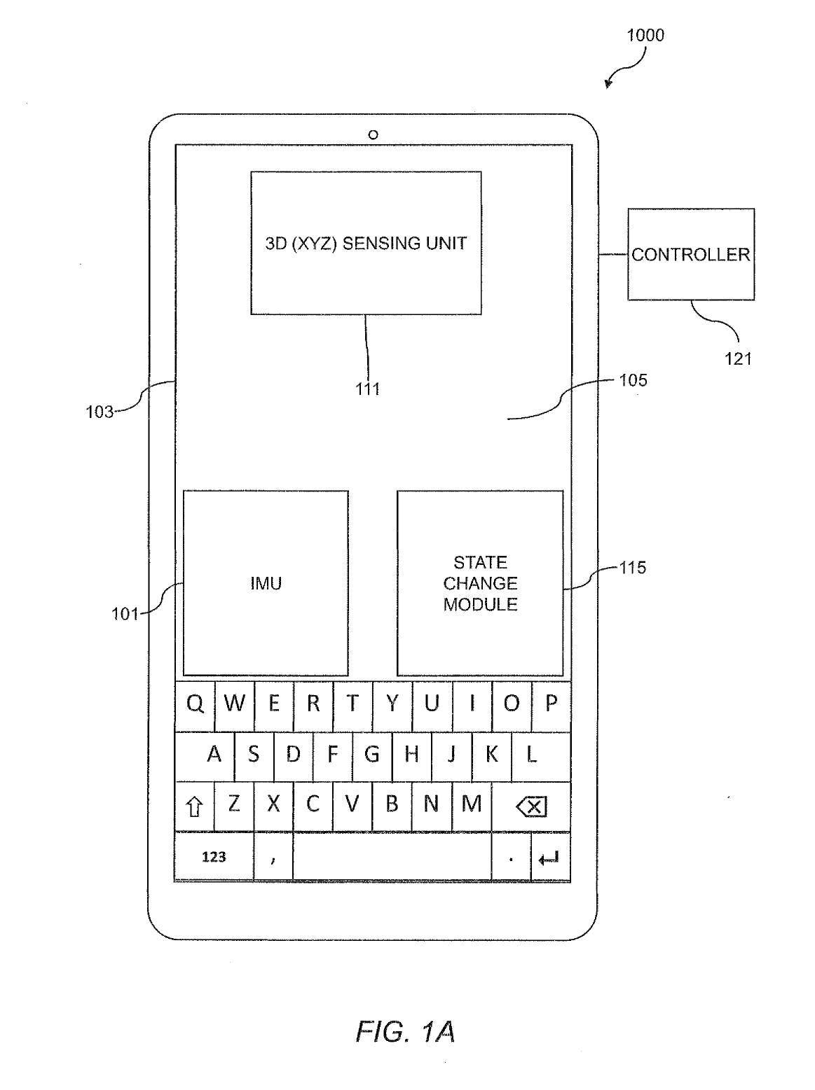

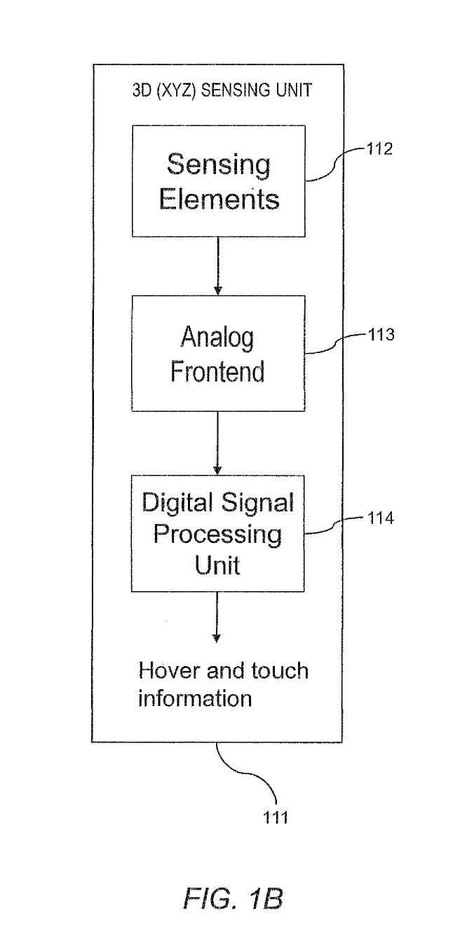

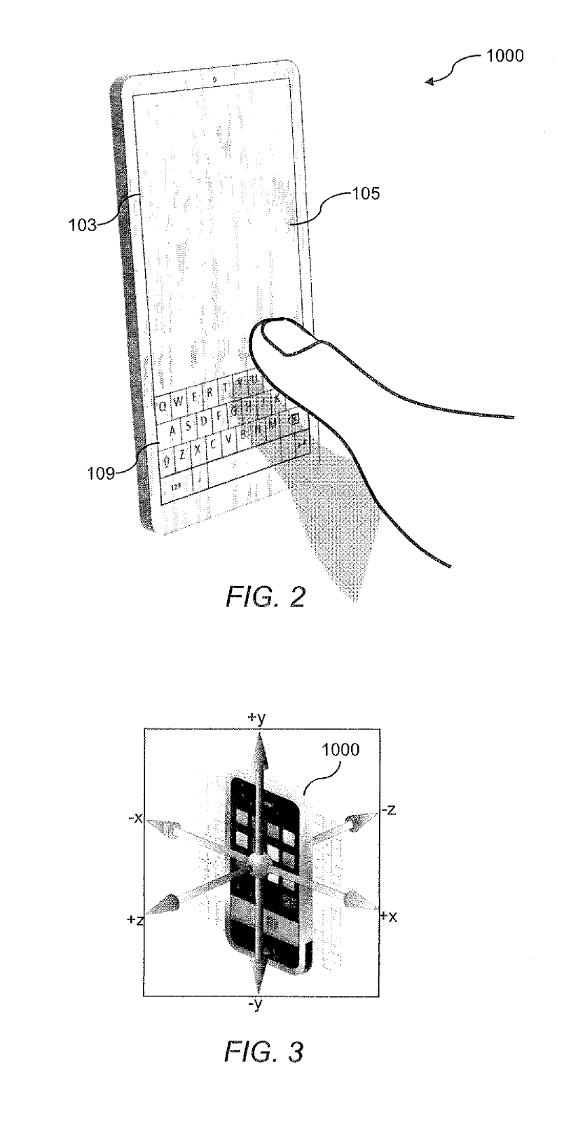

FIG. 1 discloses a mobile device 1000 that includes a touch screen system that includes a touch-sensitive and hover-sensitive surface 105 including xy dimensions and a z dimension generally orthogonal to the surface 105 of the screen. FIG. 2 shows mobile device 1000 with a user's finger hovering above keyboard 109 that currently forms a part of the user interface displayed on the touch screen. The xyz dimensions relative to the mobile device 1000 are shown in FIG. 3.

Mobile device 1000 includes an inertial measurement unit (IMU) 101 that senses linear movement and rotational movement of the device 1000 in response to gestures of the user's hand holding the device. In embodiments, IMU 101 is sensitive to second order derivatives and beyond of the translation information and first order derivatives and beyond of the rotation information, but the IMU could also be based on more advanced sensors that are not constrained in this way.

Mobile device 1000 further includes a 3D sensing unit 111 (see FIG. 1B), which includes an array of sensing elements 112, an analog frontend 113, and a digital signal processing unit 114. The sensing elements 112 are located at positions of the touch-sensitive surface 105 corresponding to display locations at which images and keyboard characters may be displayed depending upon the user interface currently being shown on the screen. It is noted that the 3D sensor unit 111, as would be readily appreciated by those skilled in the art, include arrays of sensor elements that extend over virtually the entire display-capable portion of the touch screen, but are schematically shown as box elements to facilitate illustration. The array of sensing elements is configured to sense an object hovering in a z dimension above the touch screen and to detect a location in the xyz dimensions of the object hovering above the touch screen. The sensing elements are configured to detect the distance from the display screen of the finger or other object, thus also detecting if the finger or other object is in contact with the screen. It should be noted that the 3D sensing could be realized by a plurality of sensing chains 112->113->114, and that the same chain can be used in different operational modes. In embodiments, the 3D sensing unit 111 is switched between hover and touch sensing dynamically based on the value computed by digital signal processing unit 114. In embodiments, 3D sensing unit 111 may employ capacitive sensors to deliver a true 3D xyz reading, all the time using e-field technology.

Mobile device 1000 also includes a state change determination module 115 that determines state changes from a combination of an output of the IMU 101 sensing at least one of a linear movement of the device and a rotational movement of the device, the 3D sensing unit sensing an object hovering above the touch screen, and the 3D sensing unit sensing an object touching the touch screen.

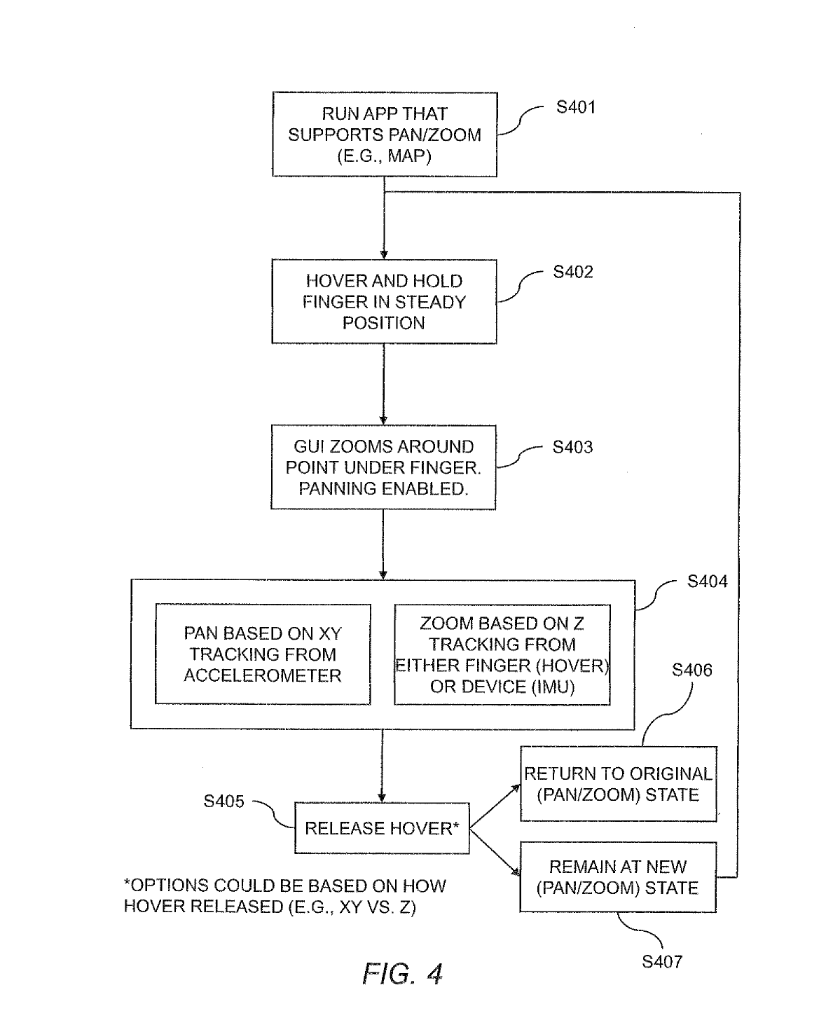

FIG. 4 is a flow chart that illustrates features of embodiments of this application. In S401, the mobile device 1000 runs an application that supports a pan/zoom function, such as a web mapping service application. In S402, the system detects a user's finger positioned in a hover mode above the display screen, and detects that the user holds the finger in a hover position for a given time period. The length of this time period may be set to any desirable value that will result in comfortable operation of the system to enable single-finger GUI state changes. In S403, the controller 121 (FIG. 1) causes the graphical user interface to zoom around a point under the hover position of the user's finger, thus enabling the panning/zooming mode in S404. The pan operation is based on xy tracking from the accelerometer of the inertial measurement unit 101, and the zoom operation is based on z tracking from the 3D sensing unit 111 or an input from the inertial measurement unit 101 based on linear movement and/or rotational movement of the device 1000 in response to gestures of the user's hand holding the device 1000. In S405, hover is released by the user; the release could be either by movement in the xy dimensions or in the z direction. In S406, hover is released in the z direction, and the operation returns to the original (pan/zoom) state. In S407, hover is released by the user moving his finger in the xy dimensions and a new hover state is initiated and the control operation moves to S402.

FIG. 5 is a flow chart that illustrates further features of embodiments of this application. In S501, the mobile device 1000 runs an application that requires mode changes, such as a keyboard application that switches among different character sets such as lower case, upper case, symbols, numerals, and different languages. In S502, the gyroscope of inertial measurement unit 101 senses a movement of the device such as a rotational tilt, e.g., clockwise. It is noted that the direction of tilt (e.g., counterclockwise) could alter gesture handling. In S503, the 3D sensing unit 111 senses whether the user's finger is positioned in a hover mode above the display screen, and detects that the user holds the finger in a hover position for a given time period. As noted above, the length of this time period may be set to any desirable value that will result in comfortable operation of the system to enable single-finger operation for GUI state changes. In S504, after it is determined that the finger is not in a hover state in S503, the system handles the movement senses by the gyroscope as a normal tilt gesture not indicating a user's intent to implement a state change, and ignores the gesture. On the other hand, in S505, after it is determined that the finger is in a hover state in S503, the system implements the appropriate state change for the gesture detected by the gyroscope, for example, a switch of the keyboard display from letters to numbers.

In the embodiments that combine hover mode and accelerometer detection for enabling the pan/zoom mode, the beginning of pan/zoom operation may be triggered based on detection of a hover event. Then, the zoom level is adjusted based on hover distance in the z direction or z motion of device 1000. Then, the pan is adjusted based on xy motion of device 1000. Finally, hover is released to complete the pan/zoom mode. This procedure leverages hover sensing coupled with accelerometer sensing to integrate a pan/zoom mode. In this way, precise selection of center point for zoom is achieved, a single-finger control of zoom level is provided and a very tangible, intuitive technique is achieved for simultaneous pan/zoom, and it is easy to return to the original pan/zoom level.

In the embodiments that combine hover and a gyroscope gesture to trigger events, the gyroscope tilt gesture is sensed including considering direction of tilt and then a check is performed of whether a user's finger is in the hover state. The gesture is handled as intentional gesture, if both the hover state and the tilt gesture are confirmed. Thus, the hover sensing is employed to modify or confirm a gyroscope-sensed gesture. This provides an easier shortcut for frequent mode change and leverages gyroscope by providing cue of intent. Moreover, the system can easily differentiate between tilt gestures (e.g., clockwise versus counterclockwise).

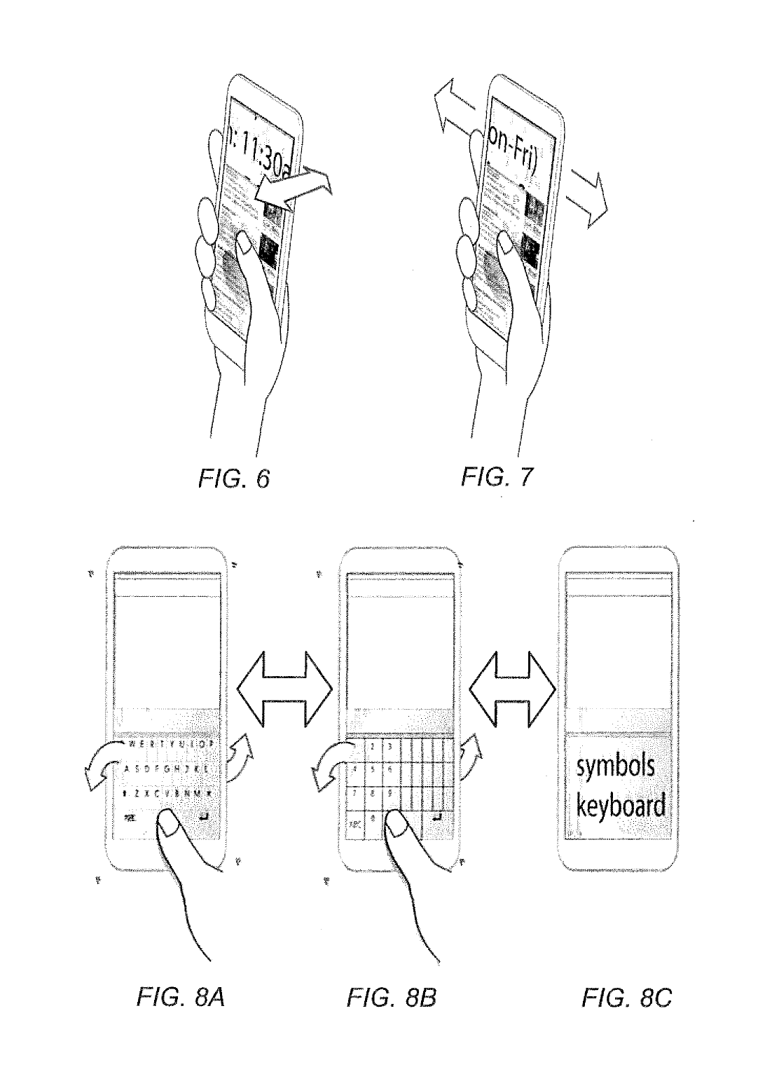

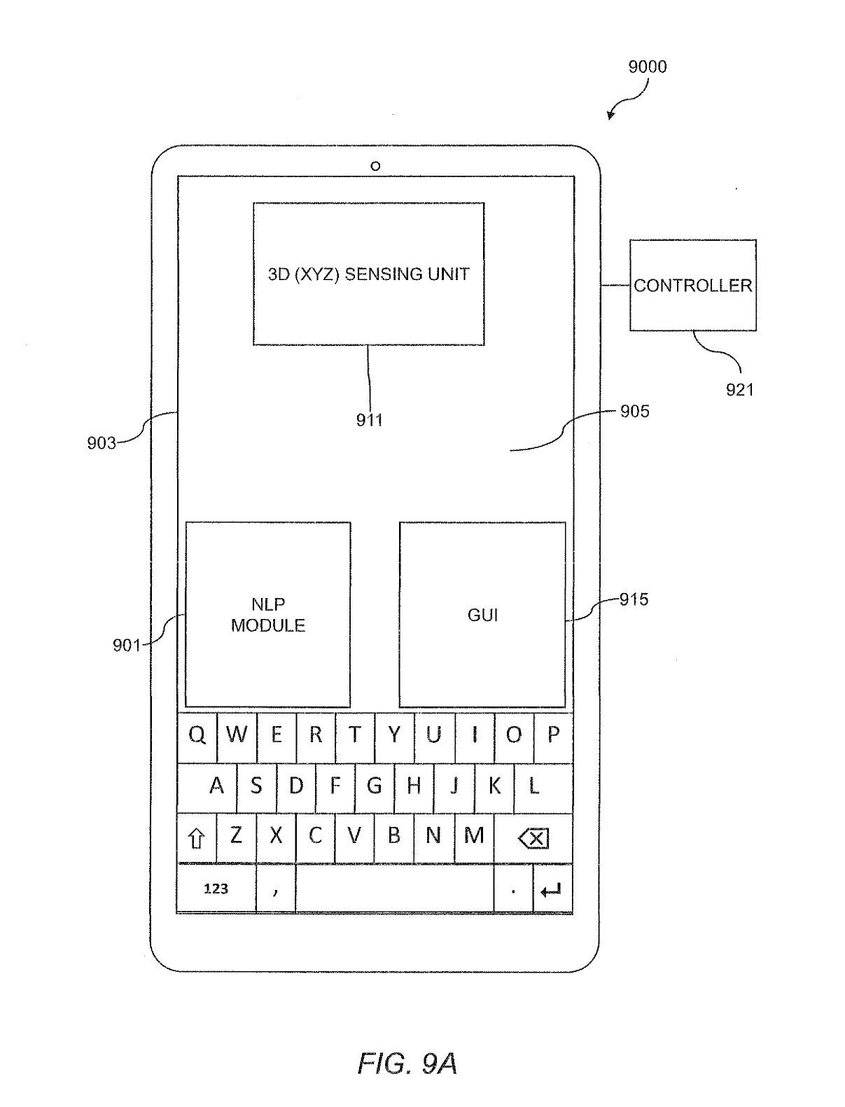

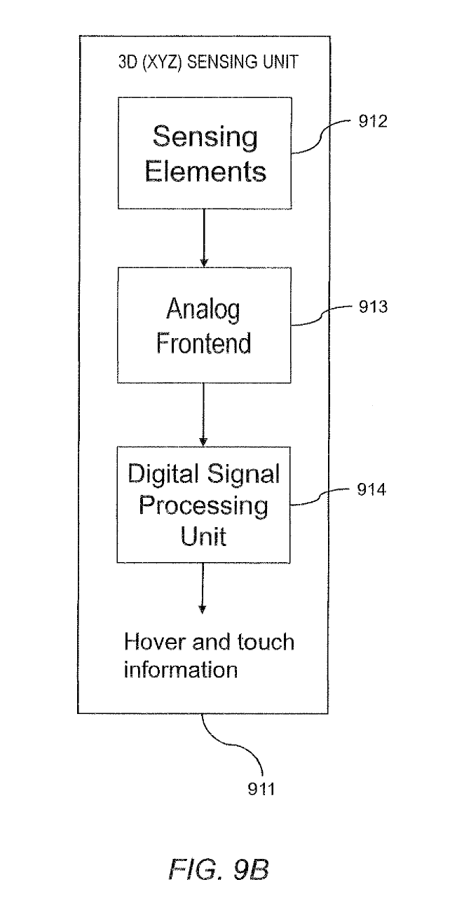

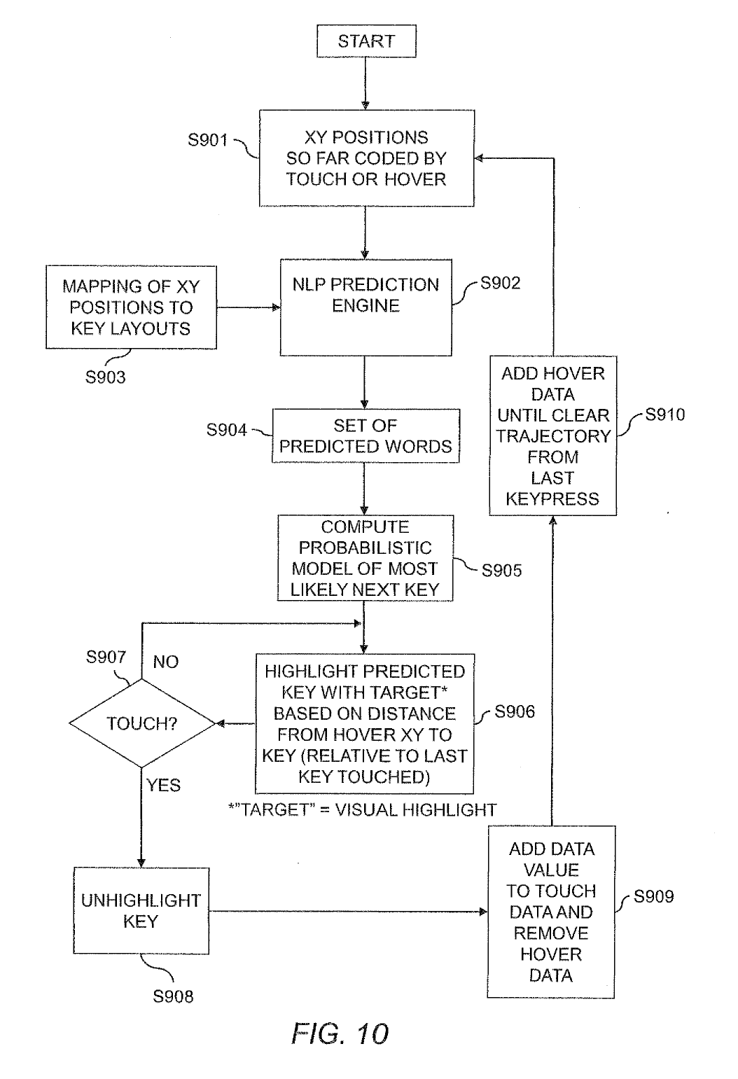

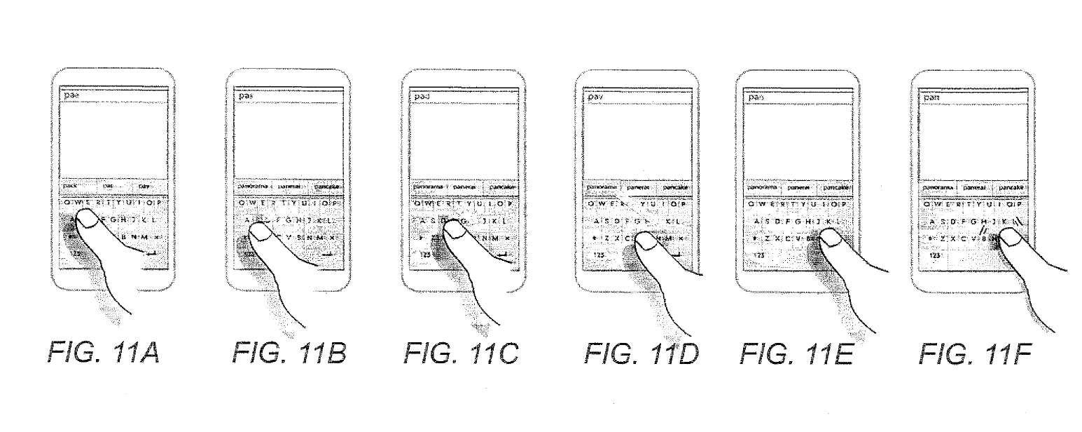

As illustrated in FIG. 6, hovering above the screen while moving the phone in the z direction facilitates a one-handed zoom, while FIG. 7 shows hovering above the screen while moving the phone in the xy dimensions facilitates one-handed panning. The phone may provide an indication to the user that hover is being sensed in order to ensure user intent. This provides an improved operation as compared to the current operations of multitouch to achieve zoom and repeated swiping to achieve pan.

As shown in FIGS. 8A, 8B and 8C, hovering above the screen while tilting triggers a mode or state change (e.g., switching keyboard modes) with a simple one-handed action. In this example, repeating the action moves to the next mode. Since the tilt is directional, tilting in the opposite direction can return to the previous mode. The user interface can include animation that provides visual feedback (e.g., keyboard sliding in/out) that is physically consistent with the direction of the hover. Simple one-handed action for frequent mode changes is advantageous in that holding a thumb above the screen is a very simple physical motion to support a shortcut like changing keyboard modes. This is easier than looking for and pressing a button. The directionality is well suited to reversing direction, so it facilitates going back to the previous mode. The system leverages hover to confirm intent without misinterpreting. One reason that gyroscope gestures have heretofore been rarely used in normal navigation is that they have been likely to give a false trigger. However, using hover gives a likely deliberate cue. The intuitive mental model reflected in the user interface feedback of a sliding user interface based on tilt is convenient for users.

### NLP Functions

FIGS. 9A and 9B disclose a mobile device 9000 that includes a touch screen system that includes a touch-sensitive and hover-sensitive surface 905 including xy dimensions and a z dimension generally orthogonal to the surface 905 of the screen. FIG. 2 shows mobile device 1000 with a user's finger hovering above keyboard 109 that currently forms a part of the user interface displayed on the touch screen.

Mobile device 9000 also includes a 3D sensing unit 911 (see FIG. 9B), which includes an array of sensing elements 912, an analog frontend 913, and a digital signal processing unit 914. The sensing elements 912 are located at positions of the touch-sensitive surface 905 corresponding to display locations at which images and keyboard characters may be displayed depending upon the user interface currently being shown on the screen. It is noted that the 3D sensor unit 911, as would be readily appreciated by those skilled in the art, include arrays of sensor elements that extend over virtually the entire display-capable portion of the touch screen, but are schematically shown as box elements to facilitate illustration. The array of sensing elements is configured to sense an object hovering in a z dimension above the touch screen and to detect a location in the xyz dimensions of the object hovering above the touch screen. The sensing elements are configured to detect the distance from the display screen of the finger or other object, thus also detecting if the finger or other object is in contact with the screen. It should be noted that the 3D sensing could be realized by a plurality of sensing chains 912->913->914, and that the same chain can be used in different operational modes. In embodiments, the 3D sensing unit 911 is switched between hover and touch sensing dynamically based on the value computed by digital signal processing unit 914. In embodiments, 3D sensing unit 911 may employ capacitive sensors to deliver a true 3D xyz reading, all the time using e-field technology.

Mobile device 9000 also includes a natural language processing (NLP) module 901 that predicts a next keyboard entry based on information provided thereto. This information includes xy positions relating to keys so far touched on the touch screen, an output from the 3D sensing unit 911 indicating xy position of the object hovering above the touch screen and indicating xy trajectory of movement of the object in the xy dimensions of the touch screen. The information further includes NLP statistical modeling data based on natural language patterns. The keyboard entry predicted by the NLP module includes at least one of a set of predicted words and a predicted next keyboard entry. Device 9000 also includes a graphical user interface (GUI) module 915 (shown in schematic form in FIGS. 9A and 9B) that highlights the predicted next keyboard entry with a visual highlight in accordance with the distance, in the xy plane, between the object hovering above the touch screen and the predicted next keyboard entry. The next keyboard entry predicted by the NLP module may also include a set of predicted words should the user decide to press the current key above which the object is hovering; and in such event, graphical user interface (GUI) module 915 presents the set of predicted words arranged around the current key above which the object is hovering as selectable buttons to enter a complete word from the set of predicted words. This is one embodiment, but in other embodiments a placement of predictions may be made, for example in a bar above the keyboard, using the same prediction algorithm.

FIG. 10 is a flow chart that illustrates features of embodiments of this application. In S901, S902, and S903, the natural language processing (NLP) module 901 receives xy positions relating to keys so far coded based on touch of the touch screen or a hover event above the touch screen, and a mapping of xy positions to key layouts. In S904, the NLP module 901 generates a set of predicted words, based on the inputs received in steps S901 and S903, and then in S905, the NLP module 901 computes a probabilistic model of the most likely next key. In S906, the system highlights the predicted next key with a target (visual highlight) having a characteristic, for example size and/or brightness, based on the distance h from current hover xy position to the xy position of the predicted next key and the distance k of the last key touched from the predicted next key. The characteristic may be determined based on an interpolation function of 1−h/k. Then, in S907, the user decides whether or not to touch the highlighted predicted next key. If the user decides not to touch the predicted next key, operation returns to S906 where the NLP module 901 highlights another predicted next key. When the user touches the predicted next key (S907), operation proceeds to remove the highlight from the key (S908) and to add a data value to the touch data stored at S901 based on the newly touched key in S907 and to remove the hover data. In S910, new hover data is added to S901 until there is a clear trajectory from the last keypress in S907. Then, the process of S902 and so on is repeated.

In embodiments, the keyboard entry predicted by the NLP module 901 may comprise a set of predicted words should the user decide to press the current key above which the object is hovering. In such embodiments, the graphical user interface (GUI) module may present the set of predicted words arranged around the current key above which the object is hovering as selectable buttons to enter a complete word from the set of predicted words. Also, in embodiments, the GUI, in accordance with the dimensions of the hover-sensed object, may control arrangement of the set of selectable buttons representing the predicted words to be positioned beyond the dimensions of the hover-sensed object to avoid visual occlusion of the user. In other embodiments, the 3D sensing unit 911 may detect a case of hovering over a backspace key to enable presenting word replacements for the last word entered. In embodiments, the GUI may independently treat the visual indicator of the predicted next keyboard entry versus the physical target that would constitute a touch of that key.

The system thus uses hover data to inform the NLP prediction engine 901. This procedure starts with the xy value of the last key touched and then adds hover xy data and hover is tracked until a clear trajectory exists (a consistent path from key). Then, the data is provided to prediction engine 901 to constrain the likely next word and hence likely next character. This constrains the key predictions based on the user's initial hover motion from the last key touched. This also enables real-time optimized predictions at an arbitrary time between keystrokes and enables the smart “attractor” functionality discussed below.

The system also adapts targeting/highlighting based on proximity of hover to the predicted key. The target is the physical target for selecting a key and may or may not directly correspond to visual size of the key/highlight). This is based on computing the distance k of the predicted next key from the last key pressed and computing the distance h of the predicted next key from the current hover position. Then, the highlighting (e.g., size, brightness) and/or target of predicted key is based on an interpolation function of (1−h/k). While this interpolation function generally guides the appearance, ramping (for example, accelerating/decelerating the highlight effect) or thresholding (for example, starting the animation at a certain distance from either the starting or attractor key) may be used as a refinement. The predicted key highlight provides dynamic feedback for targeting the key based on hover. The target visibility is less intrusive on normal typing as it is more likely to correspond to intent once the user hovers closer to the key. This technique also enables dynamic growth of the physical target as the user's intent becomes clearer based on hover closer to the predicted next key entry.

The system of this application uses trajectory based on hover xy position(s) as a data source for the NLP prediction engine 901 and highlighting based on relative distance of current hover xy position from the predicted next key entry. The system uses an attractor concept augmented with visual targeting by having the hover “fill” target when above the attractor key.

As shown in FIGS. 11A-11F, the predicted words change after a keypress based on the characters entered so far. The attractor character is based on a combination of the initial hover trajectory (e.g., finger moving down and to right from ‘a’) and word probabilities. The highlighting and physical target of the attractor adapts based on distance of the hover from the attractor key. Combined with highlighting of key above which the user's finger is hovering, this highlight/response provides a “targeting” sensation to guide and please the user.

The system provides richer prediction based on a combination of NLP with hover trajectory. The system combines the full-word prediction capabilities of existing NLP-based engines with the hover trajectory to predict individual characters. It builds on prior art that uses touch/click by applying in hover/touch domain. The system provides real-time, unobtrusive guidance to the attractor key. The use of “attractor” adapting based on distance makes it less likely to be distracting when the wrong key is predicted, but increasingly a useful guide when the right key is predicted. The “targeting” interaction makes key entry easier and more appealing. This visual approach to highlighting and moving toward a target to be filled is appealing to people due to the sense of targeting. Making the physical target of the attractor key larger reduces errors as well.

While aspects of the present invention have been described in connection with the illustrated examples, it will be appreciated and understood that modifications may be made without departing from the true spirit and scope of the invention.

What is claimed is:

1. A mobile device comprising:
an inertial measurement unit (IMU) that senses linear and rotational movement of the device in response to gestures of a user's hand while holding the device;
a touch screen system comprising (i) a touch-sensitive surface including xy dimensions, and (ii) a 3D sensing unit configured to sense an object hovering in a z dimension above the touch screen and to detect a location in the xyz dimensions of the object hovering above the touch screen; and
a state change determination module that determines state changes from a combination of (i) an output of the IMU sensing at least one of a linear movement of the device and a rotational movement of the device and (ii) the 3D sensing unit sensing the object hovering in the z dimension above the touch screen.

2. A mobile device comprising:
an inertial measurement unit (IMU) that senses linear and rotational movement of the device in response to gestures of a user's hand while holding the device;
a touch screen system comprising (i) a touch-sensitive surface including xy dimensions, and (ii) a 3D sensing unit configured to sense an object hovering in a z dimension above the touch screen and to detect a location in the xyz dimensions of the object hovering above the touch screen and sense movement of the object in the xy dimensions; and
a pan/zoom module that, in response to detection of the object hovering above the touch screen in a steady position in the xy dimensions of the touch-sensitive surface for a predetermined period of time or detection of another activation event, enables a pan/zoom mode that includes (i) panning of the image on the touch screen based on the 3D sensing unit sensing movement of the object in the xy dimensions and (ii) zooming of the image on the touch screen based on detection by the 3D sensing unit of a hover position of the object in the z dimension above the touch screen.

3. The mobile device of claim 1, wherein the state changes include changes of keyboard character sets.

4. The mobile device of claim 1, wherein the state changes are made based on one of tilt and hover or flick and hover.

5. The mobile device of claim 1, wherein the state changes are made based on one of (i) a tilt and hover operation moves to a next mode and (ii) a flick and hover operation moves to a next mode.

6. The mobile device of claim 1, wherein the state changes are made based on one of (i) performing a tilt in the opposite direction of the previous tilt and hover operation moves to a previous mode and (ii) performing a flick in the opposite direction of the previous flick and hover operation moves to a previous mode.

7. The mobile device of claim 1, further comprising a graphical user interface that provides animation that provides visual feedback to the user that is physically consistent with the direction of the hover.

8. The mobile device of claim 2, further comprising a graphical user interface that provides animation that provides visual feedback to the user that is physically consistent with the direction of the tilt or flick.

9. The mobile device of claim 2, wherein the pan/zoom module enables panning and zooming of the image in response to outputs of one or more of the 3D sensing unit and the IMU.

10. The mobile device of claim 2, wherein the pan mode is based on detection of a hover event simultaneous with movement of the device in the xy dimensions.

11. The mobile device of claim 2, wherein the zoom mode is based on detection of a hover event simultaneous with movement of the device in the z direction.

12. A method of operating a mobile device comprising:
employing an inertial measurement unit (IMU) to sense linear and rotational movement of the device in response to gestures of a user's hand while holding the device;
employing a 3D sensing unit to sense an object hovering in a z dimension above a touch-sensitive surface of a touch screen system that includes xy dimensions and to detect a location in the xyz dimensions of the object hovering above the touch screen; and
employing a state change determination module to determine state changes from a combination of (i) an output of the IMU sensing at least one of a linear movement of the device and a rotational movement of the device and (ii) the 3D sensing unit sensing the object hovering in the z dimension above the touch screen.

13. A method of operating a mobile device comprising:
employing an inertial measurement unit (IMU) to sense linear and rotational movement of the device in response to gestures of a user's hand while holding the device;
employing a 3D sensing unit to sense an object hovering in a z dimension above a touch-sensitive surface of a touch screen system that includes xy dimensions and to detect a location in the xyz dimensions of the object hovering above the touch screen and sense movement of the object in the xyz dimensions; and
employing a pan/zoom module that responds to detection of the object hovering above the touch screen in a steady position in the xy dimensions of the touch-sensitive surface for a predetermined period of time or another activation event to enable a pan/zoom mode that includes (i) panning of the image on the touch screen based on the 3D sensing unit sensing movement of the object in the xy dimensions and (ii) zooming of the image on the touch screen based on detection by the 3D sensing unit of a hover position of the object in the z dimension above the touch screen or on movement of the device in the z dimension.

14. A method of operating a mobile device comprising: detecting, by a 3D sensing unit comprising an array of hover sensors, a hover event comprising a user's finger hovering over a touch screen surface for a predetermined time period and detecting, by an inertial measurement unit (IMU), at least one of a linear and a rotational movement of the mobile device while the hover event is detected, to enable at least one of a pan/zoom mode and a state change of the mobile device.

15. A computer-readable storage medium containing program code enabling operation of a mobile device, the medium comprising:
program code for operating an inertial measurement unit (IMU) to sense linear and rotational movement of the device in response to gestures of a user's hand while holding the device;
program code for operating a 3D sensing unit to sense an object hovering in a z dimension above a touch-sensitive surface of a touch screen system that includes xy dimensions and to detect a location in the xyz dimensions of the object hovering above the touch screen; and
program code for operating a state change determination module to determine state changes from a combination of (i) an output of the IMU sensing at least one of a linear movement of the device and a rotational movement of the device and (ii) the 3D sensing unit sensing the object hovering in the z dimension above the touch screen.

16. A computer-readable storage medium containing program code enabling operation of a mobile device, the medium comprising:
program code for operating an inertial measurement unit (IMU) to sense linear and rotational movement of the device in response to gestures of a user's hand while holding the device;
program code for operating a 3D sensing unit to sense an object hovering in a z dimension above a touch-sensitive surface of a touch screen system that includes xy dimensions and to detect a location in the xyz dimensions of the object hovering above the touch screen and sense movement of the object in the xyz dimensions; and
program code for operating a pan/zoom module that responds to detection of the object hovering above the touch screen in a steady position in the xy dimensions of the touch-sensitive surface for a predetermined period of time or detection of another activation event to enable a pan/zoom mode that includes (i) panning of the image on the touch screen based on the 3D sensing unit sensing movement of the object in the xy dimensions and (ii) zooming of the image on the touch screen based on detection by the 3D sensing unit of a hover position of the object in the z dimension above the touch screen or movement of the device in the z dimension.

17. A mobile device comprising:
a touch screen system comprising (i) a touch-sensitive surface including xy dimensions, and (ii) a 3D sensing unit configured to sense an object hovering in a z dimension above the touch screen and to detect a location in the xyz dimensions of the object hovering above the touch screen and sense movement of the object in the xy dimensions;
a natural language processing (NLP) module that predicts a keyboard entry based on information comprising (i) xy positions relating to keys so far touched on the touch screen, (ii) an output from the 3D sensing unit indicating xy position of the object hovering above the touch screen and indicating xy trajectory of movement of the object in the xy dimensions of the touch screen, and (iii) NLP statistical modeling based on natural language patterns, the keyboard entry predicted by the NLP module comprising at least one of a set of predicted words and a predicted next keyboard entry; and
a graphical user interface (GUI) module that highlights the predicted next keyboard entry with a visual highlight in accordance with xy distance of the object hovering above the touch screen to the predicted next keyboard entry.

18. The mobile device of claim 17, wherein:
the GUI, in response to the object not touching the predicted next keyboard entry, continues the visual highlight until the NLP module changes the predicted next keyboard entry, and, in response to the object touching the predicted next keyboard entry, removes the visual highlight, and
the information provided to the NLP module is updated with the touching of the previously highlighted keyboard entry and current hover and trajectory of the object and the NLP module generates another predicted next keyboard entry based on the updated entry.

19. A mobile device comprising:
a touch screen system comprising (i) a touch-sensitive surface including xy dimensions, and (ii) a 3D sensing unit configured to sense an object hovering in a z dimension above the touch screen and to detect a location in the xy dimensions of the object hovering above the touch screen and sense movement of the object in the xy dimensions;
a natural language processing (NLP) module that predicts a keyboard entry based on information comprising (i) xy positions relating to keys so far touched on the touch screen, (ii) an output from the 3D sensing unit indicating xy position of the object hovering above the touch screen and indicating the current key above which the object is hovering, and (iii) NLP statistical modeling based on natural language patterns, the keyboard entry predicted by the NLP module comprising a set of predicted words should the user decide to press the current key above which the object is hovering; and
a graphical user interface (GUI) module that presents the set of predicted words arranged around the current key above which the object is hovering as selectable buttons to enter a complete word from the set of predicted words.

20. The mobile device of claim 19, wherein the GUI, in accordance with the dimensions of the hover-sensed object, controls arrangement of the set of selectable buttons representing the predicted words to be positioned beyond the physical extent of the hover-sensed object to avoid visual occlusion of the user.

21. The mobile device of claim 18, wherein the 3D sensing unit detects a case of one of hovering over or pressing a backspace key to enable presenting word replacements for the last word entered.

22. The mobile device of claim 19, 20, or 21, wherein the GUI independently treats the visual indicator of the predicted next keyboard entry versus the physical target that would constitute a touch of that key, wherein one of (i) the visual indicator is larger than the physical target area to attract more attention to the key while requiring a normal keypress or (ii) the physical target area is enlarged to facilitate pressing the target key without distorting the visible keyboard.

23. A method of operating a mobile device comprising:
employing a 3D sensing unit to sense an object hovering in a z dimension above a touch-sensitive surface of a touch screen system that includes xy dimensions and to detect a location in the xy dimensions of the object hovering above the touch screen and sense movement of the object in the xy dimensions;
employing a natural language processing (NLP) module to predict a keyboard entry based on information comprising (i) xy positions relating to keys so far touched on the touch screen, (ii) an output from the 3D sensing unit indicating xy position of the object hovering above the touch screen and indicating xy trajectory of movement of the object in the xy dimensions of the touch screen, and (iii) NLP statistical modeling based on natural language patterns, the keyboard entry predicted by the NLP module comprising at least one of a set of predicted words and a predicted next keyboard entry; and
employing a graphical user interface (GUI) module to highlight the predicted next keyboard entry with a visual highlight in accordance with xy distance of the object hovering above the touch screen to the predicted next keyboard entry.

24. The method of claim 23, wherein:
the GUI is employed to continue the visual highlight until the NLP module changes the predicted next keyboard entry, and, in response to the object touching the predicted next keyboard entry, removes the visual highlight, and
the information provided to the NLP module is updated with the touching of the previously highlighted keyboard entry and current hover and trajectory of the object and the NLP module generates another predicted next keyboard entry based on the updated entry.

25. A method of operating a mobile device comprising:
employing a 3D sensing unit to sense an object hovering in a z dimension above a touch-sensitive surface of a touch screen system that includes xy dimensions and to detect a location in the xy dimensions of the object hovering above the touch screen and sense movement of the object in the xy dimensions;
employing a natural language processing (NLP) module that predicts a keyboard entry based on information comprising (i) xy positions relating to keys so far touched on the touch screen, (ii) an output from the 3D sensing unit indicating xy position of the object hovering above the touch screen and indicating the current key above which the object is hovering, and (iii) NLP statistical modeling based on natural language patterns, the keyboard entry predicted by the NLP module comprising a set of predicted words should the user decide to press the current key above which the object is hovering; and
employing a graphical user interface (GUI) module that presents the set of predicted words arranged around the current key above which the object is hovering as selectable buttons to enter a complete word from the set of predicted words.

26. The method of claim 25, wherein the GUI, in accordance with the dimensions of the hover-sensed object, is employed to control arrangement of the set of selectable buttons representing the predicted words to be positioned beyond the physical extent of the hover-sensed object to avoid visual occlusion of the user.

27. The method of claim 25, wherein the 3D sensing unit is employed to detect a case of one of hovering over or pressing a backspace key to enable presenting word replacements for the last word entered.

28. The method of claim 25, 26, or 27, wherein the GUI is employed to independently treat the visual indicator of the predicted next keyboard entry versus the physical target that would constitute a touch of that key, wherein one of (i) the visual indicator is larger than the physical target area to attract more attention to the key while requiring a normal keypress or (ii) the physical target area is enlarged to facilitate pressing the target key without distorting the visible keyboard.

29. The method of claim 25, wherein the next keyboard entry comprises a set of predicted words should the user decide to press the current key above which the object is hovering; and a graphical user interface (GUI) module that presents the set of predicted words arranged around the current key above which the object is hovering as selectable buttons to enter a complete word from the set of predicted words.

30. The method of claim 25, wherein the natural language processing unit predicts a next keyboard entry in accordance with an output from the 3D sensing unit indicating xy trajectory of movement of the user's finger in the xy dimensions of the touch screen.

31. A method of operating a mobile device comprising:
detecting, by a 3D sensing unit comprising an array of hover sensors, a hover event comprising a user's finger hovering over a touch screen surface for a predetermined time period, and
predicting, by a natural language processing unit, a next keyboard entry in accordance with the detected hover event and NLP statistical modeling based on natural language patterns.

32. A computer-readable storage medium containing program code enabling operation of a mobile device, the medium comprising:
program code for employing a 3D sensing unit to sense an object hovering in a z dimension above a touch-sensitive surface of a touch screen system that includes xy dimensions and to detect a location in the xy dimensions of the object hovering above the touch screen and sense movement of the object in the xy dimensions;
program code for employing a natural language processing (NLP) module to predict a keyboard entry based on information comprising (i) xy positions relating to keys so far touched on the touch screen, (ii) an output from the 3D sensing unit indicating xy position of the object hovering above the touch screen and indicating xy trajectory of movement of the object in the xy dimensions of the touch screen, and (iii) NLP statistical modeling based on natural language patterns, the keyboard entry predicted by the NLP module comprising at least one of a set of predicted words and a predicted next keyboard entry; and
program code for employing a graphical user interface (GUI) module to highlight the predicted next keyboard entry with a visual highlight in accordance with xy distance of the object hovering above the touch screen to the predicted next keyboard entry.

33. A computer-readable storage medium containing program code enabling operation of a mobile device, the medium comprising:
program code for employing a 3D sensing unit to sense an object hovering in a z dimension above a touch-sensitive surface of a touch screen system that includes xy dimensions and to detect a location in the xy dimensions of the object hovering above the touch screen and sense movement of the object in the xy dimensions;
program code for employing a natural language processing (NLP) module that predicts a keyboard entry based on information comprising (i) xy positions relating to keys so far touched on the touch screen, (ii) an output from the 3D sensing unit indicating xy position of the object hovering above the touch screen and indicating the current key above which the object is hovering, and (iii) NLP statistical modeling based on natural language patterns, the keyboard entry predicted by the NLP module comprising a set of predicted words should the user decide to press the current key above which the object is hovering; and
program code for employing a graphical user interface (GUI) module that presents the set of predicted words arranged around the current key above which the object is hovering as selectable buttons to enter a complete word from the set of predicted words.
